(19) United States
(12) Patent Application Publication
(10) Pub. No.: US 2005/0001820 A1
(43) Pub. Date: Jan. 6, 2005

(54) Keyboard

(75) Inventor: Hyung-Bae Lee, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/730,051

(22) Filed: Dec. 9, 2003

(30) Foreign Application Priority Data
Jul. 1, 2003 (KR) 2003-44388

(51) Int. Cl. G09G 5/00

(52) U.S. Cl. 345/168

(57) ABSTRACT

The present invention relates to a keyboard having a plurality of keys marked with symbols, a frame to link with the plurality of keys, and a key signal input plate disposed under the frame and generating a specific signal corresponding to the key when touched with the key. The key includes a key body having a combining part combined to the frame; a key cap combined to an upper part of the key body and marked with a predetermined symbol; a base pin protruding from a bottom part of the key body arranged so that in touching the key signal input plate it lets the key signal input plate sense that the key is operated. At least one identification pin is spaced apart from the base pin and touching or not touching the key signal input plate to output the specific signal corresponding to the symbol on the key to the key signal input plate. With this configuration, the present invention provides a keyboard with keys that are changeable in position and size as necessary.

### CROSS-REFERENCE TO RELATED APPLICATIONS

This application claims the benefit of Korean Patent Application No. 2003-44388, filed Jul. 1, 2003, in the Korean Intellectual Property Office, the disclosure of which is incorporated herein by reference.

### BACKGROUND OF THE INVENTION

1. Field of the Invention

The present invention relates to a keyboard, and more particularly, to a keyboard having changeable keys that vary in position and size as necessary.

2. Description of the Related Art

Generally, a keyboard, together with a mouse, is widely employed as an input device for a computer system.

The typical keyboard has a plurality of keys marked with symbols, a frame to layout the plurality of keys, and a key signal input plate disposed under the frame that generates a specific signal corresponding to the key that was activated.

The keyboard uses the same key arrangement as mechanical and electronic typewriter keyboards. The standard arrangement of alphabetic keys is known as a QWERTY keyboard, and the position and the size of the keys are unchangeable.

When a user presses a key marked with a predetermined symbol, the key signal input plate is touched with the pressed key. The key signal input plate then outputs and transmits a specific signal corresponding to the pressed key, to a microprocessor. Typically, the microprocessor is electrically connected to the key signal input plate.

The microprocessor is provided in the keyboard, and recognizes the symbol corresponding to the specific signal received from the key signal input plate and communicates the information on the recognized symbol to a computer.

However, in the conventional keyboard, the keys are uniformly manufactured without considering or adapting to users different sized hands. This one-size, fits all approach is inconvenient for users having big or small hands to use.

Further, in the conventional keyboard, the keys are fixed in position in the QWERTY layout, so that it is inconvenient for a user having a small hand or playing games. In this case, if the keys frequently used are located together, it will be more convenient for a user.

### SUMMARY OF THE INVENTION

Accordingly, it is an aspect of the present invention to provide a keyboard with keys that are changeable in position and size as necessary.

Additional aspects and advantages of the invention will be set forth in part in the description which follows and, in part, will be obvious from the description, or may be learned by practice of the invention.

The foregoing and/or other aspects of the present invention are achieved by providing a keyboard comprising a plurality of keys marked with symbols, a frame to settle the plurality of keys thereon, and a key signal input plate disposed under the frame and generating a specific signal corresponding to the key when touched with the key, the key comprising a key body having a combining part combined to the frame; a key cap combined to an upper part of the key body and marked with a predetermined symbol; a base pin protruding from a bottom part of the key body and touching the key signal input plate so as to let the key signal input plate sense that the key is operated; and at least one identification pin spaced from the base pin and touching or not touching the key signal input plate so as to output the specific signal corresponding to the symbol to the key signal input plate.

According to an aspect of the invention, the base pin is longer than the identification pin.

According to an aspect of the invention, the maximum number of the identification pins is limited to seven.

According to an aspect of the invention, the base pin and the identification pins are disposed to form a 2 by 4 matrix, and the identification pins are disposed in all possible combinations of positions except a position of the base pin so as to output the specific signal corresponding the symbol.

According to an aspect of the invention, on the key signal input plate are provided sectors each having a sensor to be touched with the base pin or the identification pin, forming matrices.

According to an aspect of the invention, one key covers eight sectors on the key signal input plate, corresponding to the 2 by 4 matrix combination of the base pin and the identification pins of each key.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a perspective view of a keyboard according to a first embodiment of the present invention;

FIG. 2 is a partially exploded perspective view of the keyboard of FIG. 1;

FIG. 3 is a perspective view of a key according to the first embodiment of the present invention;

FIG. 4 is a side-sectional view of the key of FIG. 3;

FIG. 5 is a bottom view of the key of FIG. 3;

FIG. 6 is a perspective view of a key according to a second embodiment of the present invention;

FIG. 7 is a bottom view of the key of FIG. 6;

FIG. 8 illustrates a position change of the key; and

FIG. 9 is a partly exploded perspective view of the keyboard of FIG. 8.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

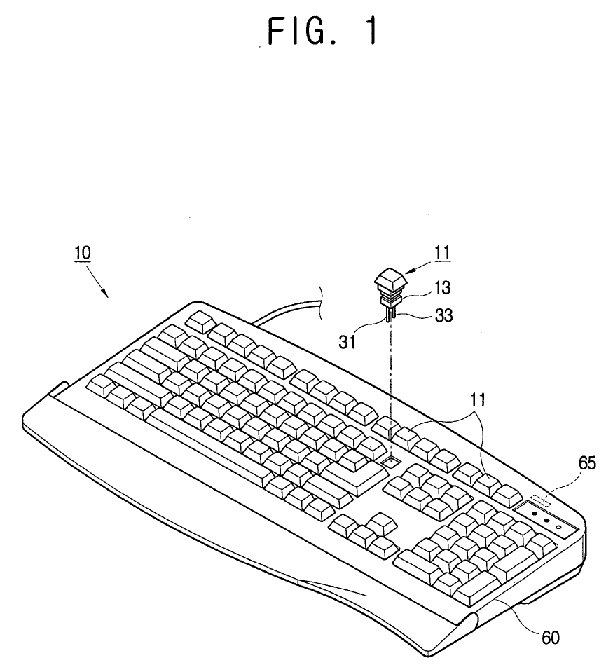

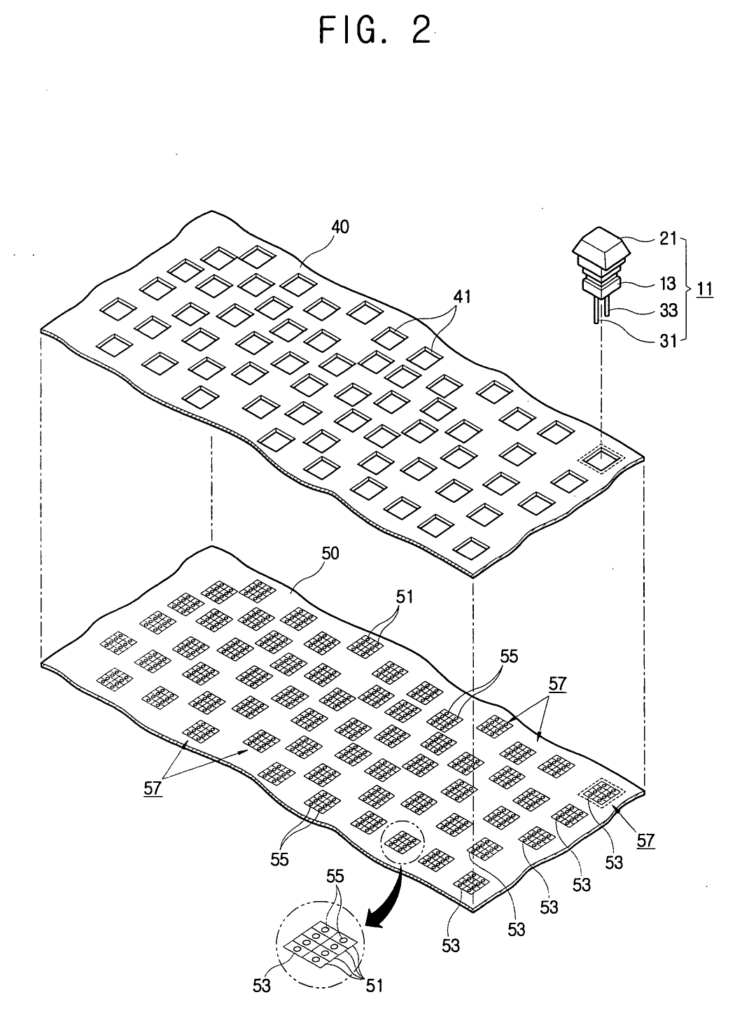

FIG. 1 is a perspective view of a keyboard according to a first embodiment of the present invention, and FIG. 2 is a partly exploded perspective view of the keyboard of FIG. 1. As shown therein, a keyboard 10 according to the present invention comprises a plurality of keys 11 marked with symbols, a frame 40 to settle or layout the plurality of keys 11 thereon, and a key signal input plate 50 disposed under the frame 40 that generates a specific signal that corresponds to the activated key 11.

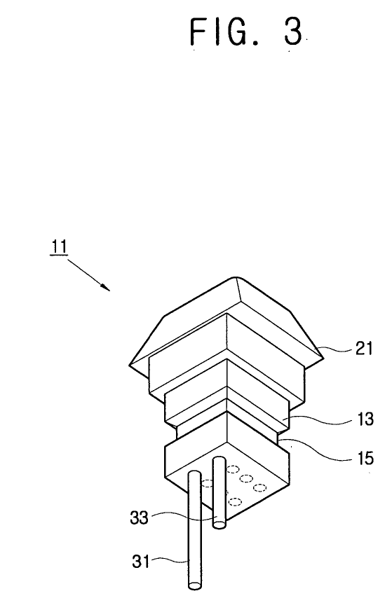

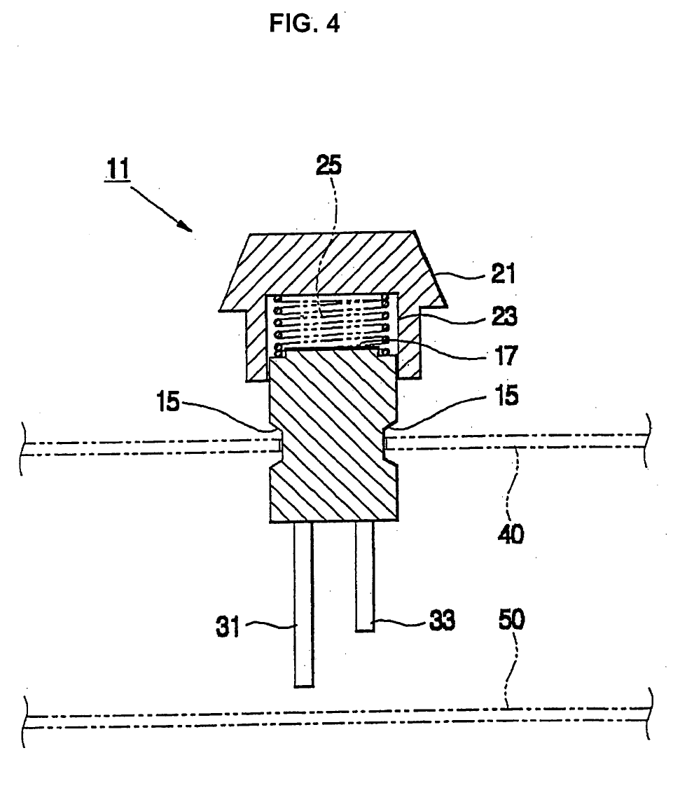

As shown in FIGS. 3 through 5, each key 11 comprises a key body 13 having a combining part 15 linked to the frame 40; a key cap 21 combined to an upper part of the key body 13 and marked with a predetermined symbol; a base pin 31 protruding from a bottom part of the key body 13 and touching the key signal input plate 50 so as to let the key signal input plate 50 sense when the key 11 is operated; and at least one identification pin 33 protruding from the bottom part of the key body 13 at a position spaced from the base pin 31 and touching or not touching the key signal input plate 50 so as to output a specific signal corresponding to the symbol to the key signal input plate 50.

The key body 13 is formed with the combining part 15 detachably fitted into a through part 41 of the frame 40 (to be described later), wherein the combining part 15 is formed by recessing circumferential sides of the key body 13 at a predetermined depth and has a width along a lengthwise direction of the key body 13 that corresponds to a distance within which the key body 13 can move up and down. The upper part of the key body 13 is formed with a spring supporting part 17 to support a spring 25 and is slidably inserted in an accommodating part 23 of the key cap 21 (to be described later).

The upper part of the key body 13 is combined with the key cap 21 marked with a predetermined symbol. The keys 11 are modularized, and the key cap 21 has a size being large enough to cover a sector block 57 provided on the key signal input part 50 (to be described later) and to prevent the key caps 21 having various sizes from interfering with each other when the position of the modularized keys 11 are changed.

In this example embodiment, the sector block 57 includes a plurality of sectors 51 and the number of the sectors 51 is limited to a multiple of eight. Hereinafter, the sector block 57 including eight sectors 51 will be exemplarily described. The key cap 21 is formed with the accommodating part 23 to accommodate the spring 25, and is detachably combined to the upper part of the key body 13. The spring 25 is interposed between the key body 13 and the key cap 21, having a first end supported by the spring supporting part 17 of the key body 13 and a second end supported by the key cap 21. Thus, when the key cap 21 is pressed, the spring 25 is compressed; at the same time the key cap 21 and the key body 13 move down. When the key cap 21 is released, the spring 25 acts to return the key cap 21 and the key body 13 to an original position. However, it is understood that other arrangements not corresponding to multiples of eight may be used.

The key body 13 is provided with a base pin 31 protruding from the bottom and touching the key signal input plate 50 when the key 11 is pressed to let the key signal input plate 50 sense that the key 11 has been operated.

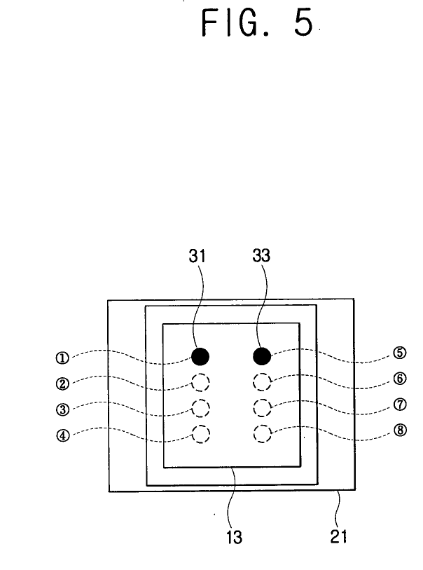

Further, the bottom part of the key body 13 is provided with at least one identification pin 33 touching or not touching the key signal input plate 50, to output the specific signal corresponding to the symbol to the key signal input plate 50. In this example embodiment, the maximum number of the identification pins 33 is seven, and the identification pins 33 are spaced from the base pin 31 at a predetermined distance. Preferably, the identification pin 33 is shorter than the base pin 31, so that when a key 11 is pushed, the base pin 31 first touches the key signal input plate 50 and then the identification pin 33 touches or does not touch the key signal input plate 50. Therefore, an operation signal related to whether a certain key 11 is operated or not is first input, and then the specific signal corresponding to the symbol of the certain key 11 is input. In this embodiment, the base pin 31 and the identification pin 33 are disposed in the bottom part of the key body 13. The pin positions form a 2 by 4 matrix pattern. For example, as shown in FIG. 5, a pin disposed in a position \mathring{1} of the key body 13 will be called the base pin 31, and a pin disposed in the other positions \mathring{2} through \mathring{8} will be called the identification pin 33. The identification pins 33 can be disposed in all possible combinations of the positions \mathring{2} through \mathring{8}, so that the key 11 can output the specific signal corresponding to its symbol by touching or not touching the key signal input plate 50 according to certain position combinations of the identification pins 33. That is, in every key 11 of the keyboard 10 according to the present invention, the key body 13 has the base pin 31 disposed in the position 01 so as to modularize the key 11 and to allow the position of the key 11 to be changed. Also, identification pins 33 disposed in all possible combinations of the positions \mathring{2} through \mathring{8} allow the key 11 to output specific signals corresponding to one hundred and twenty-eight symbols by touching or not touching the key signal input plate 50 according to the position combinations of the identification pins 33. In the example of FIG. 5, it is illustrated that only one identification pin 33 is disposed in the position \mathring{5}, wherein dotted circles indicate the positions where no identification pin 33 is disposed. However, it is understood that other numbers of pins may be used. Additionally, it is to be appreciated that other identifiers may be employed in place of pins, such as infrared and magnetic sensors, switches and actuators could be adapted to work with the present invention.

Identification pins 33 can be disposed in the positions \mathring{3} and \mathring{6}, or the positions \mathring{2}, \mathring{3}, \mathring{4}, \mathring{5}, \mathring{6}, \mathring{7} and \mathring{8}, etc. according to the symbols on the keys 11. Even if the identification pin 33 does not touch the key signal input plate 50, i.e., there is no identification pin 33 in any position Q through® of the key body 13, and only the base pin 31 touches the key signal input plate 50, a signal due to touching the key signal input plate 50 with only the base pin 31 can be input as the specific signal corresponding to a certain symbol.

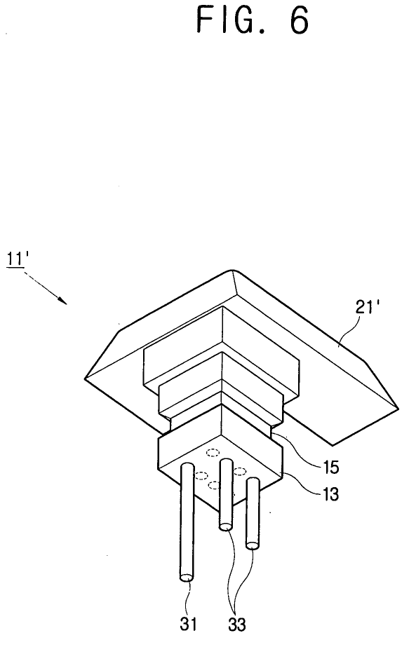

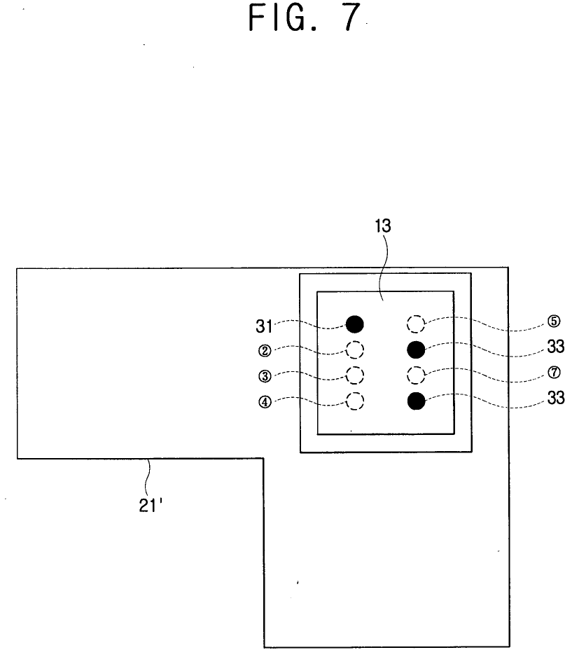

FIGS. 6 and 7 illustrate a key 11 according to a second embodiment of the present invention. As shown in this aspect of the present invention, a key 11′ includes, a key body 13 that is combined with a key cap 21′ having a shape that can be generally described as an “L”-shape and is larger than a standard key cap. Here, the key body 13 of the key 11′ in this example embodiment has the same size as the key body 13 of the key 11 according to the first embodiment, so that the key 11′ is compatibly fitted into the through part 41 of the frame 40. It is to be appreciated that other key cap shapes may also be incorporated into the frame 40. For example, a large square or rectangular shape could be easily substituted for the “L”-shape. Further, the key 11′ has a base pin 31 and an identification pin 33 that output a specific signal corresponding to a certain symbol to a key signal input plate 50. In the example of FIGS. 6 and 7, the identification pins 33 are disposed in positions \mathring{2} and \mathring{8} (by way of example but not limited to).

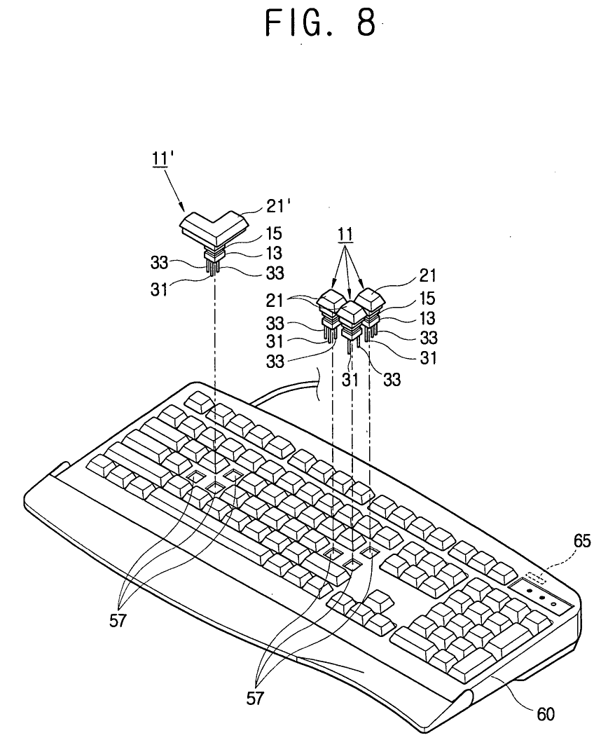

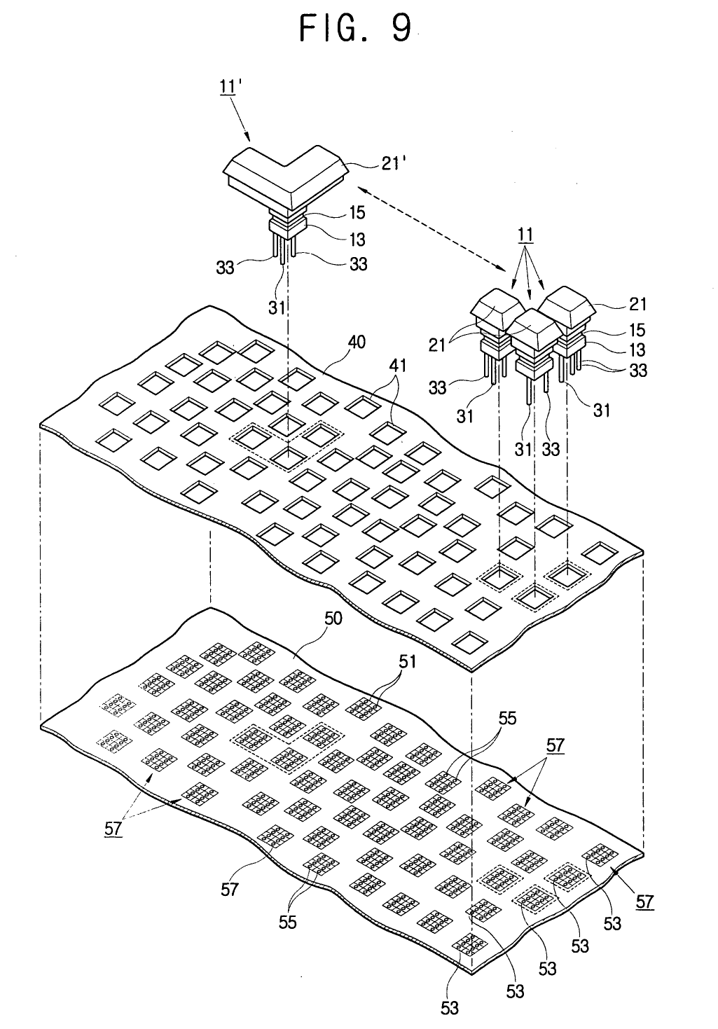

Thus, as illustrated in FIGS. 8 and 9 when the key 11′ is combined to the frame 40, the key body 13 is fitted into the through part 41 of the frame 40 and the key cap 21′ covers the through part 41 combined with the key body 13 and its neighbor area. Here, the area covered with the key cap 21′ corresponds to an area covered with a plurality of the standard key caps 21 (refer to FIG. 9).

The frame 40 is shaped like a sheet, and is formed with a plurality of through parts 41 randomly arranged on the sheet along lengthwise and widthwise directions of the frame 40. A combining part 15 of the key body 13 is detachably linked to opposite sides of each through part 41, thereby combining the key 11′ and the frame 40. The through parts 41 are disposed.

The key signal input plate 50 is a circuit board on which the sectors 51 each having a sensor 55 to sense the base pin 31 or the identification pins 33 are provided to form matrices. Each sector 51 has a sensor 55 that may be touched with the base pin 31 or the identification pin 33. In this embodiment, eight sectors 51 are provided corresponding to the 2 by 4 pin position matrix combination of the base pin 31 and the identification pins 33 of each key 11, so that one key 11 covers eight sectors 51 on the key signal input plate 50. Further, eight sectors 51 of the key signal input plate 50 forms one sector block 57, and one sector block 57 forms a single logical circuit. The sector blocks 57 are arranged on the key signal input plate 50 in correspondence to the through parts 41 of the frame 40. In every sector block 57, one sector 51 is designated as a base sector 53 corresponding to the base pin 31 of the key body 13. Even if the key 11 changes positions, the key signal input plate 50 can transmit the specific signal corresponding to the symbol of the key 11 to a microprocessor 65 because the sensors 55 provided in the sectors 51 of one sector block 57 are touched by the specific combination of the identification pins 33 of the key 11 having that symbol. Further, in the case of the key 11′ having the key cap 21′ being larger than the standard key cap, one sector block 57 is covered with the key body 13 of the key 11′ and the other sector blocks 57 belonging to the key 11′ are covered with the key cap 21′ without key body 13. It is understood that receivers other than the sensors 55 and sector blocks 57 may be used in alternative aspects of the present invention. For example, receivers could be placed on the key signal input plate 50 in groups to sense key activation. The receivers could be groups of switches or contactless sensors that respond to signals from each key.

A case 60 forms an outer appearance of the keyboard 10, and accommodates the key body 13, and the frame 40 and the key signal input plate 50. In the case 60 is provided a microprocessor 65 electrically connected to the key signal input plate 50 for recognizing the symbol corresponding to the specific signal of the key 11 received from the key signal input plate 50 and to transmit information on the recognized symbol to a computer (not shown).

With this configuration, a key of the keyboard according to the present invention operates as follows.

When a certain key 11 is pressed, the base pin 31 of the certain key 11 touches the sensor 55 of the base sector 53 belonging to a sector block 57 of the key signal input plate 50, thereby transmitting the operation signal of the certain key 11 to the microprocessor 65.

Then, the identification pins 33 of the certain key 11 touch or do not touch the sensors 55 of the other sectors 51 belonging to the sector block 57 of the key signal input plate 50, thereby transmitting the specific signal that corresponds to the certain key 11 to the microprocessor 65.

Then, the microprocessor 65 recognizes the symbol corresponding to the specific signal of the certain key 11 received from the key signal input plate 50, and transmits information on the recognized symbol to the computer.

In another aspect of the present invention, as shown in FIGS. 8 and 9, when a user wants to change the position of certain keys 11 and 11′ of the keyboard 10, the certain keys 11 and 11′ are first separated from the frame 40. Then, the key body 13 of each key 11 is fitted into the frame 40 at a desired position, with its base pin 31 being aligned with the base sector 53 belonging to the sector block 57 of the key signal input plate 50, thereby changing the position of the key 11. Here, even though the keys 11 and 11′ have changed position, the specific signals corresponding to the respective symbols of the keys 11 and 11′ are inputted to the key signal input plate 50 because the sensors 55 provided in the sectors 51 of one sector block 57 are touched by the specific combinations of the respective identification pins 33 provided in the keys 11 and 11′.

When a user wants to change the size of a certain key 11, e.g., when a user wants to change the size of the key cap into a larger one, the size of the key 11 can be easily changed by combining a larger key cap to the key body 13 provided with the identification pins 33 having the combination corresponding to a predetermined symbol. Here, in the case where the key 11′ having the key cap 21′ larger than the standard key cap is combined to the keyboard 10, the key body 13 of the key 11′ is fitted into one through part 41 of the frame 40, and the key cap 21′ covers the through part 41 combined with the key body 13 and its neighbor area, wherein the area covered with the key cap 21′ corresponds to the area covered with a plurality of the standard key caps.

According to the present invention, the base pin touches the key signal input plate to let the key signal input plate sense that the key is operated, and at least one identification pin spaced from the base pin and touching or not touching the key signal input plate outputs the specific signal corresponding to the symbol to the key signal input plate, so that the keys may be changeable in position and size as necessary.

As described above, the present invention provides a keyboard with keys that are changeable in position and size as necessary.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A keyboard comprising a plurality of keys marked with symbols, a frame to settle the plurality of keys thereon, and a key signal input plate disposed under the frame and generating a specific signal corresponding to the key when touched with the key, the key comprising:
a key body having a combining part combined to the frame;
a key cap combined to a first part of the key body and marked with a predetermined symbol;
a base pin protruding from a second part of the key body and touching the key signal input plate so as to let the key signal input plate sense that the key is operated; and
at least one identification pin spaced from the base pin and touching or not touching the key signal input plate so as to output the specific signal corresponding to the symbol.

2. The keyboard according to claim 1, wherein the base pin is longer than the identification pin.

3. The keyboard according to claim 2, wherein the maximum number of the identification pins is seven.

4. The keyboard according to claim 3, wherein the base pin and the at least one identification pins are disposable in positions that correspond to a 2 by 4 matrix, and the identification pins are disposable in all possible combinations of positions except a position of the base pin so as to output the specific signal corresponding the symbol.

5. The keyboard according to claim 4, wherein on the key signal input plate are provided sectors each having a sensor to be touched with the base pin or the at least one identification pin, forming matrices.

6. The keyboard according to claim 5, wherein the key covers at least eight sectors on the key signal input plate, corresponding to the 2 by 4 matrix position layout combination of the base pin and the at least one identification pin of each key.

7. The keyboard according to claim 6, wherein the key cap has a size being large enough to cover the sectors provided on the key signal input plate, wherein the number of sectors is a multiple of eight.

8. A keyboard comprising:
a case;
a plurality of keys, wherein each key has an arrangement of pins that correspond to a predetermined symbol marked on each key;
a frame, disposed in the case, that each key detachably links with to maintain a chosen position; and
a key signal input plate, disposed in the case, having a plurality of sector blocks corresponding to each key, wherein each sector block outputs signals in response to the arrangement of pins on each key.

9. The keyboard as in claim 8, wherein the keys are relocatable as desired on the frame wherein the key retains a symbol identity based on the pin arrangement of the key.

10. The keyboard as in claim 9, wherein some of the keys have different size and shape tops relative to the other tops of the other keys.

11. The keyboard as in claim 8, wherein the arrangement of pins of each key includes a base pin at a set location to indicate actuation of the key and any remaining arrangement of pins indicate the symbol identity of that key.

12. The keyboard as in claim 11, wherein the pins are arrangeable in a 2 by 4 matrix pattern.

13. The keyboard as in claim 11, wherein the base pin is longer than any other pins in the arrangement on the bottom of each key.

14. A keyboard having keys that may be relocated to positions that do not correspond to a QWERTY layout comprising:
a plurality of keys each having a key cap, a key body, and an arrangement of at least one pin on the bottom of the key body,
a frame having a plurality of apertures sized to link with key body;
a key signal input plate disposed under the frame and having a plurality of sector blocks corresponding to each aperture, wherein each sector block includes a plurality of sensors that output signals in response to the arrangement of pins on the bottom of each key; and
a case that houses the frame, key signal input plate and the keys.

15. The keyboard as in claim 14, wherein the key caps are not all the same size and shape.

16. The keyboard as in claim 15, wherein each key cap is marked with a predetermined symbol and the arrangement of the at least one pin uniquely corresponds to the predetermined symbol.

17. The keyboard as in claim 15, wherein the keys may be moved to different locations on the frame and whereby the key retains its symbol identity based on the pin arrangement on the bottom of the key.

18. The keyboard as in claim 17, wherein the arrangement of pins of each key includes a base pin at a set location to indicate actuation of the key and any remaining arrangement of pins indicate the symbol identity of that key.

19. The keyboard as in claim 18, wherein the base pin is longer than any other pins in the arrangement on the bottom of each key.

20. The keyboard as in claim 14, wherein the sensors are arranged in a matrix pattern that is a multiple of eight.

21. The keyboard as in claim 14, wherein the each sector block of the key signal input plate is comprised of eight sensors that correspond to a maximum of eight pins on each key.

22. A keyboard comprising:
a case;
a plurality of keys arranged in the case in a predetermined pattern, wherein each key has identifiers that correspond to a predetermined symbol marked on each key;
a key signal input plate, disposed in the case, having receivers corresponding to each key, wherein the receivers output signals in response to the identification means corresponding to each key.

23. The keyboard as in claim 22, wherein a frame is disposed in the case to detachably link with each key to maintain the each key in a chosen position.

24. The keyboard as in claim 22, wherein the identifiers are comprising a unique arrangement of pins on each key that correspond to the predetermined symbol.

25. The keyboard as in claim 22, wherein the receivers further comprise individual sensors to sense the arrangement of the pins.
